(19) United States
(12) Patent Application Publication
(10) Pub. No.: US 2004/0083694 A1
(43) Pub. Date: May 6, 2004

(54) Filter for vacuum cleaner

(76) Inventor: Keon-Soo Choi, Gwangju-City (KR)

Correspondence Address: LADAS & PARRY, 224 SOUTH MICHIGAN AVENUE, SUITE 1200, CHICAGO, IL, 60604, US

(21) Appl. No.: 10/691,192

(22) Filed: Oct. 22, 2003

(30) Foreign Application Priority Data
Nov. 5, 2002 (KR) 2002-68103

(51) Int. Cl. B01D 46/00

(52) U.S. Cl. 55/357; 55/498; 55/428; 55/467

(57) ABSTRACT

Disclosed is a vacuum cleaner filter which is detachably mounted into a dust collecting chamber of a main body of the vacuum cleaner and which filters dust contained in the air sucked into an air inlet of the dust collecting chamber, said filter comprising: a cylindrical filter body having a plurality of open parts and an external screw section on the outer periphery of the upper part thereof; a porous filter paper for covering the open parts; and a cover having a through hole fitting with the air inlet and an internal screw section corresponding to the external screw section. Since the cover is screwed to be tightly fastened to the filter body, it is possible to secure a complete closing of the filter body with the cover even when the filter is used for a long time.

### CROSS-REFERENCE TO RELATED APPLICATIONS

This application claims the benefit of Korean Patent Application No. 2002-68103 filed Nov. 5, 2002, in the Korean Intellectual Property Office, the disclosure of which is incorporated herein by reference.

### BACKGROUND

1. Field of the Invention

The present invention relates to a vacuum cleaner, and more particularly to a semipermanently usable filter for a vacuum cleaner.

2. Description of the Related Art

As generally known in the art, a vacuum cleaner sucks dust, dirt and debris on a floor with external air by a sucking force generated at an influx port and separately collects the dust, dirt and debris contained in the sucked air by a dust collecting means.

A dust bag is commonly used as a dust collecting means. When filled with dust, the dust bag is separated from a vacuum cleaner and thrown away. Therefore, the replacement of new dust bags increases the expenses of using a vacuum cleaner.

To solve this problem, semipermanently usable filters have recently been developed to replace disposable dust bags. When filled with dust, a semipermanent filter can be separated from the main body of a vacuum cleaner and cleaned to be reusable in the vacuum cleaner.

FIG. 1 shows a conventional reusable filter and a vacuum cleaner with the filter inserted therein.

Referring to FIG. 1, a filter 100 comprises a filter body 110 with an open top and a cover 120 detachably coupled to the open top.

The filter body 110 has a shape similar to a dust collecting chamber 11 of a main body 10 of the vacuum cleaner. More specifically, the filter body 110 has a front surface 112 having a through hole 111 and side surfaces 114 having guide grooves 113 into which fixing guides 12 of the dust collecting chamber 11 are fitted. Being made of a porous plastic material, the filter body 110 itself can function to filter dust.

When the filter 100 is filled with dust, the user can open the cover 120 to remove the dust from the filter 100. The cover 120 is made of a plastic material and provided with a pair of holes 121 on the top thereof.

The filter 100 is mounted into the dust collecting chamber 11, with the fixing guides 12 being inserted into the guide grooves 113 formed on the side surfaces 114 of the filter 100. At this time, the through hole 111 of the filter 100 exactly fits with an air inlet 13 of the dust collecting chamber 11.

During operation of the vacuum cleaner, exterior air containing dust is sucked into an brush 20 and then introduced into the filter 100 through the air inlet 13 and the through hole 111. Dust contained in the air is filtered and collected by the filter, while the clean air is exhausted out through the rear of the filter 100. When the filter 100 is full of dust, the user can separate the filter 100 from the dust collecting chamber 11 of the main body 10 of the vacuum cleaner and insert it again into the dust collecting chamber 11 after removing the dust.

In the filter 100 having the above structure, the cover 120 is pressed down to be coupled to the filter body 110. Accordingly, if either the cover 120 or the filter body 110 is distorted and is thus incompletely coupled, the collected dust in the filter 100 will likely leak outside.

Also, it is not easy to separate the filter 100 from the dust collecting chamber 11. The user should hold the filter body 100 with both hands and pull it upward to take out the filter 100 from the dust collecting chamber 11.

In addition, the user should dust off in an unsanitary way using both hands to clean the filter 100, which inevitably makes his or her hands dirty.

### SUMMARY OF THE INVENTION

Accordingly, the present invention has been made to solve the above-mentioned problems occurring in the prior art, and an aspect of the present invention is to provide a vacuum cleaner filter which can secure a complete closing of a filter body with a cover to prevent leakage of dust and which can be easily cleaned in a sanitary way.

In order to accomplish the above aspect and/or other features of the present invention, there is provided a vacuum cleaner filter which is detachably mounted into a dust collecting chamber of a main body of the vacuum cleaner and which filters dust contained in the air sucked into an air inlet of the dust collecting chamber, said filter comprising: a cylindrical filter body having a plurality of open parts and an external screw section on the outer periphery of the upper part thereof; a porous filter paper for covering the open parts; and a cover having a through hole fitting with the air inlet and an internal screw section corresponding to the external screw section.

Preferably, the cover is provided with a cover handgrip.

Preferably, the filter body has a handgrip on one side thereof.

Also, it is preferable to provide a pair of guide projections on at least one of the cover and the filter body to guide the filter to be properly mounted into the dust collecting chamber.

Also, it is preferable to provide a plurality of supporting projections on the lower surface of the filter body in order to space the filter body at a predetermined distance from the bottom surface of the dust collecting chamber.

### BRIEF DESCRIPTION OF THE DRAWINGS

The above objects and other advantages of the present invention will be more apparent from the following detailed description taken in conjunction with the accompanying drawings, in which:

FIG. 1 is a perspective view of a conventional reusable filter a vacuum cleaner including the same filter.

FIG. 2 is a perspective view of a filter according to a preferred embodiment of the present invention.

FIG. 3 is a view showing the separation of the filter of FIG. 2 from the main body of a vacuum cleaner.

FIG. 4 is a view showing the separation of a cover from a filter body of FIG. 2.

### DETAILED DESCRIPTION OF THE PREFERRED EMBODIMENTS

Hereinafter, a preferred embodiment of the present invention will be described in detail with reference to the accompanying drawings.

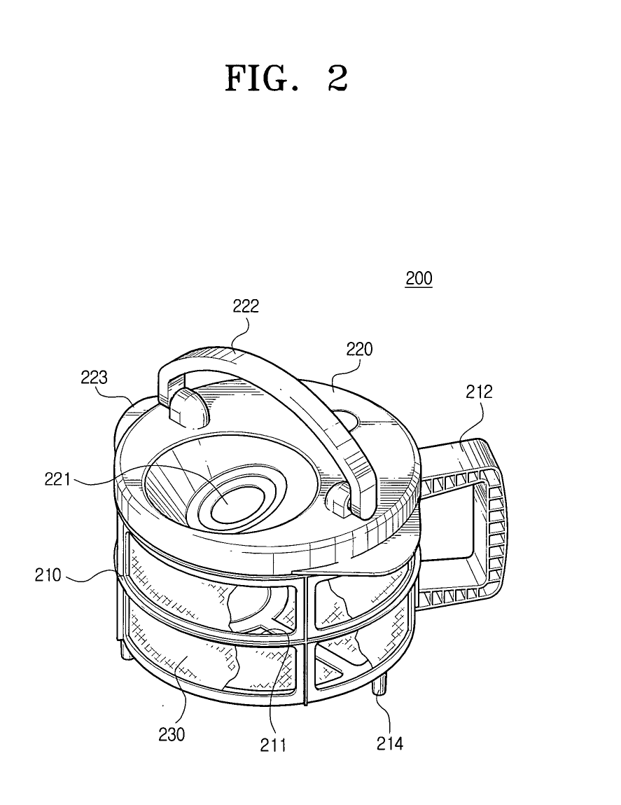

As shown in FIG. 2, a vacuum cleaner filter 200 according to the present invention comprises a filter body 210 and a cover 220 detachably fastened to the top opening of the filter body 210.

The filter body 210 is in a cylindrical shape having a plurality of open parts 211 on the side and bottom thereof. The open parts 211 are covered with a porous filter paper 230, such as a non-woven fabric, so that the filter body 210 can have a space for storing a predetermined amount of dust. Exterior air containing dust is sucked into the filter body 210 and passes through the open parts 211 and the filter paper 230 to be exhausted outside the filter body 210. Only dust filtered by the filter paper 230 is collected in the filter body 210.

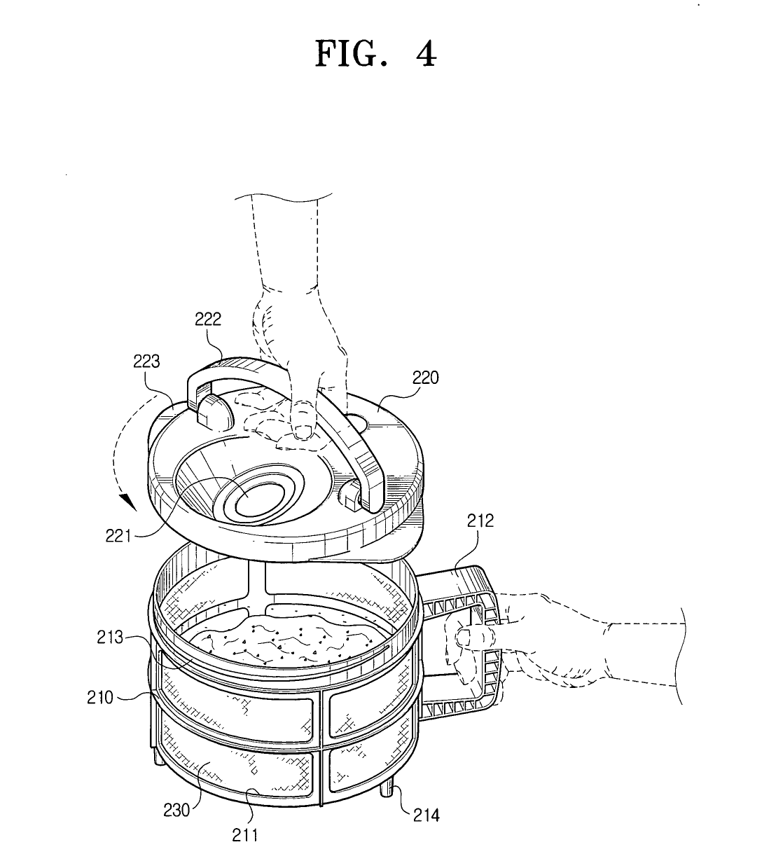

The filter body 210 has an outer screw section 213 on the outer periphery of the upper part thereof for a spiral connection with the cover 220 as shown in FIG. 4. Also, a handgrip 212 is provided on one side of the filter body 210. The user can hold the handgrip 212 when removing dust collected in the filter body 210.

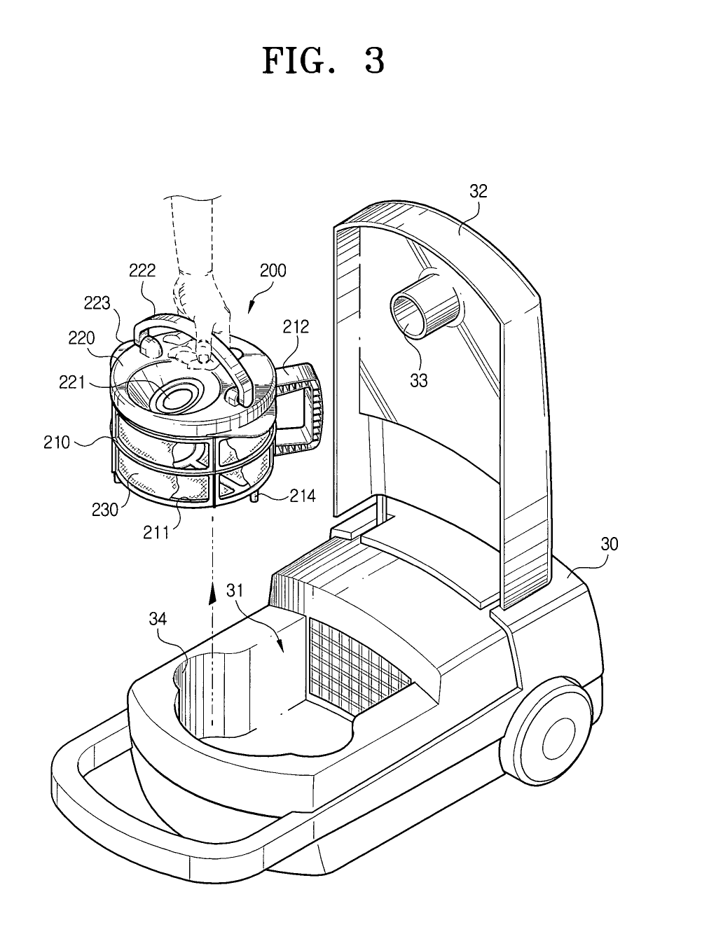

In addition, the filter body 210 has a plurality of supporting projections 214 on the lower surface thereof. When the filter 200 is mounted into a dust collecting chamber 31 (FIG. 3), it can be spaced at a predetermined distance from the bottom surface of the dust collecting chamber 31 due to the supporting projections 214. Accordingly, the air sucked into the filter body 210 can be exhausted outside through the open parts 211 formed on both the side and the bottom of the filter body 210.

The cover 220 has an inner screw section (not shown) corresponding to the outer screw section 213 of the filter body 210. When the cover 220 is turned clockwise at a predetermined angle, for example 45°, the inner screw section is engaged with the outer screw section 213, thereby fastening the cover 220 to the top opening of the filter body 210. The cover 220 has a through hole 221 for introducing the exterior air containing dust into the filter body 210. When the filter 200 is mounted into the dust collecting chamber 31(FIG. 3), the through hole 221 fits with an air inlet 33 (FIG. 3) formed on the dust collecting cover 32 (FIG. 3) of a main body 30 (FIG. 3) of the vacuum cleaner.

The cover 220 has a cover handgrip 222 on the top surface thereof. As shown in FIG. 3, the user can easily separate the filter 200 from the dust collecting chamber 31 by lifting up the filter 200 using the cover handgrip 222. Preferably, the cover handgrip 222 should be designed to be turned and laid down to reduce the space for mounting the filter 200 within the dust collecting chamber 31.

Also, the cover 220 has a pair of guide projections 223 on both sides thereof. The outer circumferences of the guide projections 223 have the same shape as the inner circumferences of a pair of guide recesses 34 formed on the inner surface of the dust collecting chamber 31 as shown in FIG. 3. The guide projections 223 are slidably inserted into the guide recesses 34 so that the filter 200 can be exactly mounted into a proper place within the dust collecting chamber 31, i.e., into a place where the through hole 221 can exactly fit with the air inlet 33.

Preferably, the filter 220 is made of a transparent material to enable the user to easily check the amount of dust collected in the filter body 210.

The operation of the vacuum cleaner filter 200 according to the present invention will be explained in more detail with reference to FIGS. 3 and 4.

The user can mount the filter 200 into the dust collecting chamber 31 of the main body 30 of the vacuum cleaner using the cover handgrip 222. The guide projections 223 of the cover 220 slides down along the guide recesses 34 formed on the inner surface of the dust collecting chamber 31, thereby resting the filter 200 on a proper place within the dust collecting chamber 31 where the through hole 221 fits exactly with the air inlet 33 of the dust collecting cover 32.

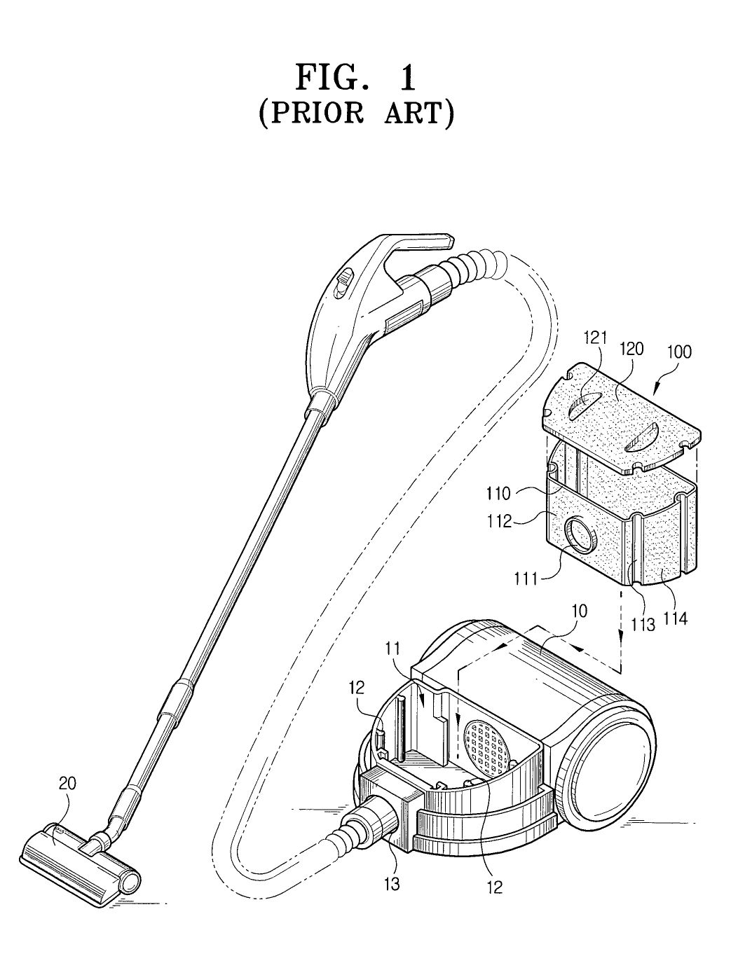

During operation of the vacuum cleaner, exterior air containing dust, dirt and debris is sucked into the brush 20 (see FIG. 1) and introduced into the filter body 210 through the air inlet 33 and the through hole 221 of the filter 200. The air passes through the filter papers 230 covering the open parts 211 formed on the side and bottom of the filter body 210 and is introduced into the dust collecting chamber 31 of the main body 30 and finally exhausted outside the main body 30. The dust, dirt and debris sucked with the air are filtered by the filter papers 230 and collected in the filter body 210.

When the filter body 210 is full of dust, dirt and debris, the user can open the dust collecting cover 220 and take out the filter 200 from the dust collecting chamber 31 by lifting up the filter 200 using the cover handgrip 222. After separating the filter 200 from the dust collecting chamber 31, the user can separate the cover 220 from the filter body 210 by turning the cover 220, holding the handgrip 212 of the filter body 210 with one hand and the cover handgrip 222 with the other hand. Then, the user can sweep off the dust, dirt and debris collected in the filter body 210 by tilting the filter body 210.

The filter body 210 is closed again with the cover 220 and installed into the dust collecting chamber 31.

As described above, the cover 220 is screwed to the filter body 210. Since the filter body 210 is tightly closed with the cover 220, it is possible to prevent the leakage of dust from the filter body 210.

When the user wishes to dust off the filter 200, he or she can easily separate the filter 200 from the dust collecting chamber 31 using the cover handgrip 222 provided on the cover 220. Also, the user can easily remove the dust, dirt and debris collected in the filter body 210 using the handgrip 212 of the filter body 210 and the cover handgrip 222, without making his or her hands dirty.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A vacuum cleaner filter which is detachably mounted into a dust collecting chamber of a main body of the vacuum cleaner and which filters dust contained in the air sucked into an air inlet of the dust collecting chamber, said filter comprising:
a cylindrical filter body having a plurality of open parts and an external screw section on the outer periphery of the upper part thereof;
a porous filter paper for covering the open parts; and
a cover having a through hole fitting with the air inlet and an internal screw section corresponding to the external screw section.

2. The vacuum cleaner filter according to claim 1, wherein said cover is provided with a cover handgrip.

3. The vacuum cleaner filter according to claim 1, wherein said filter body has a handgrip on one side thereof.

4. The vacuum cleaner filter according to claim 1, wherein a pair of guide projections are formed on at least one of the cover and the filter body to guide the filter to be properly mounted into the dust collecting chamber.

5. The vacuum cleaner filter according to claim 1, wherein a plurality of supporting projections are formed on the lower surface of the filter body in order to space the filter body at a predetermined distance from the bottom surface of the dust collecting chamber.
